(19) United States
(12) Patent Application Publication
(10) Pub. No.: US 2025/0065399 A1
(43) Pub. Date: Feb. 27, 2025

(54) METHOD OF FABRICATING A METAL MATRIX COMPOSITE (MMC) FEEDSTOCK MATERIAL FOR ADDITIVE MANUFACTURING, AND METHOD OF ADDITIVELY MANUFACTURING A MMC COMPONENT

(71) Applicant: Gamma Alloys, Inc., Valencia, CA (US)

(72) Inventors: Yuzheng Zhang, Stevenson Ranch, CA (US); William C. Harrigan, JR., Porter Ranch, CA (US); Mark Sommer, Pacific Palisades, CA (US); Micah Lee Peabody, Seminole, FL (US)

(21) Appl. No.: 18/806,970

(22) Filed: Aug. 16, 2024

Related U.S. Application Data
(60) Provisional application No. 63/533,801, filed on Aug. 21, 2023.

(51) Int. Cl. B22F 1/12; B22F 10/22; B22F 10/70; B22F 12/53; B33Y 10/00; B33Y 70/10

(52) U.S. Cl. CPC B22F 1/12; B22F 10/22; B22F 10/70; B22F 12/53; B33Y 70/10; B22F 2301/052; B22F 2302/00; B33Y 10/00

(57) ABSTRACT

A method of preparing a feedstock material for additive manufacturing includes: processing powders into a billet, the billet comprising a metal matrix composite including nanoscale ceramic particles embedded in an aluminum alloy matrix; extruding the billet into an extruded preform, whereby the nanoscale ceramic particles are substantially fully embedded within grains and/or grain boundaries of the aluminum alloy matrix; and forming a feedstock material for additive manufacturing from the extruded preform, the nanoscale ceramic particles being or remaining substantially fully embedded within the aluminum alloy matrix.

### RELATED APPLICATION

The present patent document claims the benefit of priority under 35 U.S.C. 119(e) to U.S. Provisional Patent Application No. 63/533,801, which was filed on Aug. 21, 2023 and is hereby incorporated by reference in its entirety.

### TECHNICAL FIELD

The present disclosure relates generally to additive manufacturing and more specifically to methods of fabricating a metal matrix composite (MMC) feedstock material and additively manufacturing a component from the feedstock material.

### BACKGROUND

Additive manufacturing, sometimes referred to as 3D printing, refers to the fabrication of net shape components by material deposition in a layer by layer process. In contrast to subtractive manufacturing, where components are formed into a desired size and shape by material removal (e.g., machining, cutting, filing, etc.), additive manufacturing allows complex components to be built “from the bottom up” with little material waste. Additive manufacturing has been widely applied to the fabrication of polymer parts, and some 3D printing methods can be employed to produce metal components. Challenges may arise in the additive manufacturing of composite materials.

### BRIEF DESCRIPTION OF THE DRAWINGS

The embodiments may be better understood with reference to the following drawing(s) and description. The components in the figures are not necessarily to scale. Moreover, in the figures, like-referenced numerals designate corresponding parts throughout the different views.

FIG. 1 is a flow chart showing exemplary steps in a method of producing a feedstock material comprising an aluminum MMC for additive manufacturing, including an optional step of additively manufacturing a component from the feedstock material.

FIGS. 2A-2D show field emission scanning electron microscopy (FE-SEM) images at different magnifications of regions of an additively manufactured component comprising an aluminum MMC; the images were obtained after hot isostatic pressing and heat treatment of the additively manufactured component.

### DETAILED DESCRIPTION

Described in this disclosure are methods of fabricating a MMC feedstock material for additive manufacturing and also additively manufacturing a MMC component from the feedstock material. Of particular interest are aluminum-based MMCs. The processing is controlled to ensure that nanoscale ceramic (reinforcement) particles are uniformly embedded within the metal matrix of the feedstock material and the final additively manufactured part. Thus, disadvantages associated with additive manufacturing of conventionally prepared composite materials can be avoided.

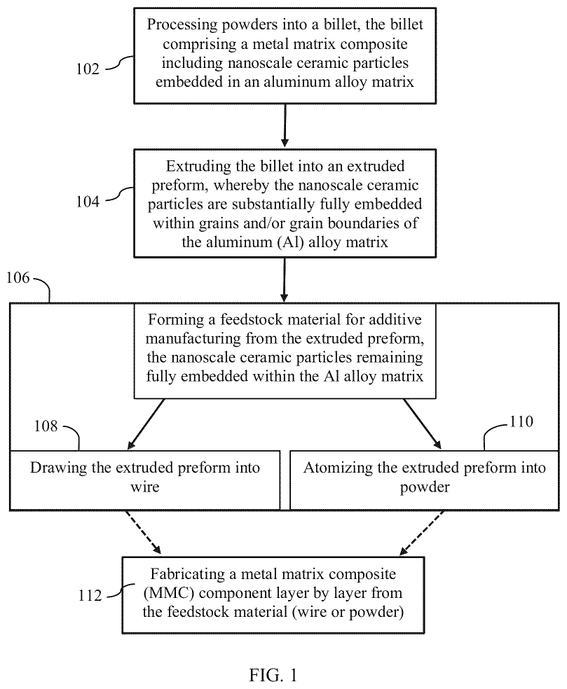

Referring to the flow chart of FIG. 1, the method of fabricating a feedstock material for additive manufacturing includes processing powders 102 into a billet using powder metallurgy methods, such as those described in U.S. Pat. No. 10,058,917, which is hereby incorporated by reference in its entirety. The billet comprises a metal (aluminum) matrix composite including nanoscale ceramic particles embedded in an aluminum alloy matrix. The nanoscale ceramic particles may comprise a metal carbide, a metal oxide, a metal boride, a metal beryllide, or another ceramic. Examples of suitable ceramics include titanium diboride, titanium carbide, tungsten carbide, zirconium oxide, yttrium oxide, and/or lanthanum oxide. Due to possible downstream exposure of the nanoscale ceramic particles to molten aluminum during additive manufacturing, the selected ceramic is preferably wettable by molten aluminum and nonreactive with molten aluminum, at least for the time periods during which additive manufacturing takes place. The aluminum alloy matrix may include aluminum and one or more alloying elements, such as copper, magnesium, manganese, nickel, silicon, silver, tin, and/or zinc. The aluminum alloy matrix may comprise a 2000, 5000, or 7000 series aluminum alloy, for example.

Advantageously, the powders employed to form the billet include microscale metal particles that are “decorated” with the nanoscale ceramic particles. In other words, the nanoscale ceramic particles are attached to surfaces of the microscale metal particles, which may take the form of elemental powders, master alloy powders, and/or prealloyed aluminum powders. Accordingly, it is understood that each microscale “metal” particle may comprise a pure (elemental) metal, such as aluminum or copper with any incidental impurities, or a metal alloy, such as an aluminum alloy. The microscale metal particles may have an average particle size of at least about 3 microns, at least about 5 microns, and/or as high as about 35 microns. The nanoscale ceramic particles may have an average particle size of at least about 1 nm and as large as about 100 nm, or as large as about 500 nm. Better dispersion may be obtained with smaller size particles. Typically, the blend includes at least about 0.1% by volume and as much as about 5% by volume of the nanoscale ceramic particles. For example, the blend may include from 1% to 5% by volume, or from 2% to 3% by volume of the nanoscale ceramic particles. Once the nanoscale ceramic particles have been attached to the microscale metal particles, as described below, the composite particles may be referred to as a decorated powder or as decorated particles.

Accordingly, processing the powders 102 into a billet may entail blending microscale metal particles and nanoscale ceramic particles to form the decorated particles, and then the decorated particles may be compacted to form the billet. Blending may entail mixing (e.g., in a high shear mixer) the microscale metal and nanoscale ceramic particles in a polar fluid, such as isopropyl alcohol. Upon removal (e.g., evaporation) of the polar fluid, the nanoscale ceramic particles may be attached to the microscale metal particles by electrostatic forces, such that the decorated particles are formed.

Suitable compaction methods to form the billet may include hot or cold pressing methods known in the art, such as vacuum hot pressing, or cold isostatic pressing followed by canning, hot isostatic pressing, and can removal. In a vacuum hot-pressing process, the blended powders maybe placed inside a suitably-sized die, and the die and blended powder may be placed inside a vacuum retort. Once the vacuum has been established, the die may be heated to a temperature suited to remove any residual moisture (water) from the blended powders. The die is then heated to the process temperature, which is typically in a range from 450° C. to 565° C., and the billet is pressed to greater than 97% theoretical density. During compaction, the microscale metal particles densify to form the aluminum alloy matrix within the billet, and the nanoscale ceramic particles at the surfaces of the metal particles are incorporated at grain boundaries of the aluminum alloy matrix.

A further metal working process, such as extrusion, may allow shear deformation to redistribute the nanoscale ceramic particles throughout the aluminum alloy matrix and into the grains. Accordingly, referring again to FIG. 1, the billet may be extruded 104 into an extruded preform (e.g., a rod), whereby the nanoscale ceramic particles are substantially fully embedded within grains and/or grain boundaries of the aluminum alloy matrix. Extrusion may utilize, for example, a two-hole die able to provide an extrusion (or area) ratio, that is, an initial cross-sectional area divided by a final cross-sectional area, in a range from about 30:1 to about 60:1, or from about 40:1 to about 50:1.

After fabrication of the extruded preform, the precursor or feedstock material for additive manufacturing may be formed 106. The feedstock material may take the form of wire or powder, e.g., atomized powder, which may be produced as described below. Advantageously, the nanoscale ceramic particles may become or remain fully embedded within the aluminum alloy matrix during formation of the feedstock material, such that, preferably, the entire surface of the feedstock material comprises the aluminum alloy matrix. Consequently, the sub-surface or embedded nanoscale ceramic particles are not exposed during additive manufacturing, and associated processing problems (e.g., particle scattering) can be avoided. The nanoscale ceramic particles may be described as being “substantially fully embedded” within the aluminum alloy matrix, which may be understood to mean that at least about 90 vol. %, at least about 95 vol. %, or at least about 99 vol. %, and up to 100 vol. %, of the nanoscale ceramic particles are fully embedded within the aluminum alloy matrix.

The extruded preform can be metalworked (drawn) 108 to form wire. Typically, the process is carried out at room temperature (e.g., 18-25° C.) and is thus referred to as cold drawing. The extruded preform may be pulled (drawn) through a die to form the wire, which has a smaller diameter than that of the extruded preform. The volume of material remains the same during drawing, and thus the length of the wire increases as the diameter decreases. Drawing may be followed by an anneal, or heat treatment, to relieve strain in the material. The wire may undergo multiple drawing steps through dies of successively smaller diameters with intermediate anneals to reach the final desired diameter, which may be as small as about 1 mm and is most commonly 1.2 mm, but may be as large as 5 mm in diameter. As with the extruded preform, the wire comprises a metal matrix composite where the nanoscale ceramic particles are fully embedded within the aluminum alloy matrix. The wire may be employed as a feedstock material for wire-based additive manufacturing, such as directed energy deposition (DED) methods that utilize lasers, electron beams, or electric arcs to induce melting of the wire.

Alternatively, the extruded preform may be atomized 110 into powder that can be screened as needed into appropriate sizes for powder-based additive manufacturing. During atomization, a spray of gas or liquid impinges upon a stream of molten metal, which is formed from the molten metal matrix of the extruded preform. The spray of gas or liquid may comprise water or an inert gas such as nitrogen, helium or argon. Due to the impingement, the stream is broken up into droplets, which cool rapidly and solidify into particles (powder). The atomized powder may comprise spherical or irregular particles ranging in size from about 10 microns to about 100 microns. In some cases, the powder may be screened to a preferred particle size range for additive manufacturing, e.g., in a range from 25 microns to 65 microns. Due to the good wettability of the nanoscale ceramic particles by molten aluminum, as described above, the nanoscale ceramic particles may be completely coated by the molten metal matrix during atomization, such that the resulting atomized particles contain fully embedded nanoscale ceramic particles. The atomized powder, typically after undergoing screening for particle size control, may be employed as a feedstock for powder-based additive manufacturing, such as powder bed fusion methods.

The wire-based or powder-based feedstock material, prepared as described above, may be employed to fabricate a component layer by layer 112 from the feedstock material. Advantageously, the resulting additively manufactured or printed component comprises the metal matrix composite described above, where the nanoscale ceramic particles are fully embedded within the aluminum alloy matrix.

Fabricating the component layer by layer 112 may comprise, in one example, delivering the feedstock material into a printhead, melting the feedstock material to form a molten material, and depositing the molten material onto a substrate in successive layers while the printhead is moved relative to the substrate in an x-, y- and/or z-direction, typically by a computer-controlled micro-positioner. This additive manufacturing approach may be adapted for use with wire and/or powder feedstock materials. The molten material comprises the molten aluminum matrix material mixed with the nanoscale ceramic particles, where the nanoscale ceramic particles are preferably both wettable by and nonreactive with the molten aluminum matrix, at least for the time periods during which additive manufacturing takes place. Using this approach, the component may be built up to a desired size and shape layer by layer. The melting may take place within the printhead or at a printhead outlet (e.g., nozzle opening). The molten material solidifies during or after deposition onto the substrate. In one example, sometimes referred to as fused deposition modeling (FDM) or fused filament fabrication (FFF), the printhead may be heated such that the feedstock material within softens, melts and is extruded through the nozzle opening. In examples referred to as DED methods, a laser, electron beam, or electric arc may be used to directly heat the feedstock material, e.g., at the nozzle opening.

In another example, fabricating the component layer by layer 112 may comprise depositing the feedstock material onto a substrate to form a layer, and melting one or more selected regions of the layer, followed by cooling to solidify the selected region(s). Typically, this method utilizes powders as the feedstock material. A laser or other localized heat source, such as an electron beam, may be used to melt the selected region(s) of the layer while being moved relative to the substrate in an x- and/or y-direction, typically by a computer-controlled micro-positioner. As the laser or electron beam moves, particles within the selected region(s) melt and are bonded together upon cooling. After printing of the layer, the substrate may be moved down (in a z-direction) for deposition of additional feedstock material to form an additional layer. The depositing, melting and cooling may be repeated multiple times to build the component up layer by layer. Such approaches to additive manufacturing may be referred to as selective laser melting (SLM) or selective laser sintering (SLS). It is noted that particles within each layer that are outside the selected region(s) do not undergo melting; thus, they may be removed from the substrate after the layer is printed or after the component is complete. Beneficially, these particles may be recycled after removal from the substrate. Accordingly, the method may further comprise collecting excess (unmelted) feedstock material, and reusing the excess feedstock material to fabricate an additional layer or additional component (e.g., using SLM or another method).

In yet another example, fabricating the component layer by layer 112 may comprise delivering the feedstock material into a nozzle, and spraying the precursor material out of an opening of the nozzle onto a substrate while the nozzle is moved relative to the substrate in an x-, y-, and/or z-direction, typically by a computer-controlled micropositioner. During this process, the feedstock material adheres to the substrate, and the component may be built up to a desired size and shape layer by layer. The spraying is normally carried out at a temperature at which the feedstock material remains in the solid state (i.e., does not undergo melting), and thus this additive manufacturing approach may be referred to as cold spray or supersonic particle deposition. As in the preceding approach, the method may further comprise collecting excess feedstock material, and reusing the excess feedstock material to fabricate an additional component comprising the metal matrix composite layer by layer (e.g., using cold spray or another method).

Advantageously, the nanoscale ceramic particles may remain stable during melting and solidification of the aluminum alloy matrix, which may occur during atomization and/or additive manufacturing. In some examples, fabrication of the component layer by layer 112 (i.e., additive manufacturing) may be followed by additional process steps to obtain the desired final microstructure in the aluminum metal matrix composite (MMC). For example, the printed component may undergo additional densification processing, such as hot isostatic pressing, and/or heat treatment. The presence of the nanoscale ceramic particles may beneficially promote a columnar (or dendritic) to equiaxed grain conversion in the aluminum alloy matrix during a recrystallization heat treatment. The presence of the nanoscale ceramic particles is also believed to be critical to preventing the formation of dendrites during solidification, e.g., during freezing of a weld pool during 3D printing Aluminum alloys, such as 2000 and 7000 series alloys, tend to freeze in a dendritic fashion without the presence of the nanoscale ceramic particles. Dendrites formed during solidification have planes of weakness that may lead to cracks, and thus such unreinforced alloys are considered unweldable. By incorporating the nanoscale ceramic particles into the aluminum alloys, weldable aluminum MMCs may be formed.

### EXAMPLES

### Fabrication of an Extruded Preform Comprising an Aluminum MMC

A first example is the manufacturing of an extruded preform comprising a 7000 series aluminum alloy with 1 vol. % titanium carbide (TiC) nanoparticles. Microscale aluminum powder (148 lb) is blended with Al—Mg master alloy powder with 50% Mg (10.84 lb), Al—Cu master alloy powder with 50% Cu (7.68 lb), Al—Zn master alloy powder containing 40% Zn (33.33 lb), and TiC nanoscale powder (3.5 lb). The blending is carried out as described above, such that the TiC nanoscale particles decorate the microscale aluminum and aluminum alloy powders. The blended powders are then compacted into a 12-inch diameter steel die to a density of approximately 60% theoretical. The die and powder are placed inside a vacuum retort and sealed. The vacuum retort and die assembly are placed in a furnace and the vacuum is applied to the retort. The assembly is heated to 800° F. and held until the vacuum level indicates that all trapper water has been removed. The assembly is then heated to the process temperature, which is in the range from 450° C. to 565° C., as described above. Once the assembly has been equilibrated at the process temperature, the billet is pressed to a theoretical density greater than 97%. The final billet length is approximately 17 inches. The billet is removed from the die and extruded from 12-inch diameter to a 1.75-inch diameter rod (the extruded preform), which corresponds to an extrusion ratio of 47:1. The extruded preform is approximately 60 feet long. After extrusion, the extruded preform is cut into lengths suitable for atomization. Alternatively, the extruded preform of this example may be used to prepare wire feedstock for additive manufacturing.

A second example is the manufacturing of an extruded preform comprising a 2024 aluminum alloy with 1 vol. % titanium boride (TiB₂) nano particles. 2024 aluminum alloy powder (5.7 lb) is blended with TiB₂ nano particles (0.1 lb). The blending is carried out as described above, such that the TiB₂ nanoscale particles decorate the microscale aluminum alloy powders. The blended powders are placed inside a 3.5-inch diameter die. The die and powder are placed inside a vacuum retort. Once the vacuum has been established, the die is heated to 800° F. and held at that temperature until the vacuum level indicates that all water has been removed from the powder. The die is the heated to the process temperature and the billet is pressed to greater than 97% theoretical density. The final billet length is 6 inches. The billet is then extruded into a 0.375-inch diameter rod (the extruded preform). For this extrusion, a two-hole die is used for an area ratio of 43.6:1. The extruded preform is used to prepare wire feedstock for additive manufacturing. Alternatively, the extruded preform of this example may be used in an atomization process to prepare powders.

### Fabrication and Characterization of an Additively Manufactured Component

Powders were blended to create 2000 series aluminum and 7000 series aluminum alloys including nanoscale ceramic powders, in particular, TiC. The blended powders were made into billets and then extruded into rods (extruded preforms), as described above. The extruded preforms were atomized and screened to generate powders with appropriate particle size distributions for powder bed fusion printing. Tensile coupons were printed, and then underwent hot isostatic pressing, or “HIP”ing, to produce fully dense aluminum matrix composites. The samples were then heat treated to a high strength condition and tensile tested at various temperatures.

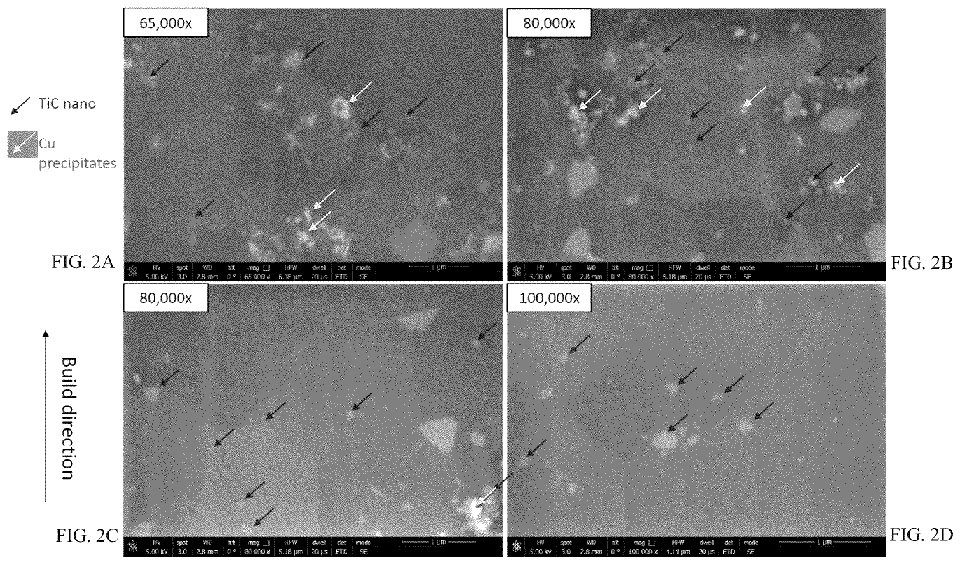

The gage sections of the tensile samples were sectioned and polished in order to observe the microstructure using field emission scanning electron microscopy (FE-SEM). The grip sections of the samples were used for observation to minimize and deformation during the testing. FIGS. 2A-2D show the microstructure that was observed at different magnifications in one of the samples. FE-SEM analysis of the 2000 and 7000 series samples show that the majority of the nanoscale ceramic particles are at the grain boundaries and are indeed nanoscale (sub-100 nm) in size. The grain boundaries also have some natural precipitates (e.g., Al—Cu precipitates), as expected. A small fraction (e.g., less than 5%) of the nanoscale ceramic particles are present inside the grains. The microstructure is a mixture of coarser-grained (e.g., 20-40 μm) and finer-grained (e.g., 1-10 μm) regions, where the finer-grained regions are associated with a higher number density of nanoscale TiC particles, as expected based on the grain-refining effect of TiC nanoparticles. The grains are equiaxed and not dendritic, which provides evidence that the nanoscale ceramic particles transformed the structure as anticipated.

This disclosure includes the following aspects:

A first aspect relates to a method of fabricating a metal matrix composite feedstock material for additive manufacturing, the method comprising: processing powders into a billet, the billet comprising a metal matrix composite including nanoscale ceramic particles embedded in an aluminum alloy matrix; extruding the billet into an extruded preform, whereby the nanoscale ceramic particles are substantially fully embedded within grains and/or grain boundaries of the aluminum alloy matrix; and forming a metal matrix composite (MMC) feedstock material for additive manufacturing from the extruded preform, the nanoscale ceramic particles remaining substantially fully embedded within the aluminum alloy matrix.

A second aspect relates to the method of the preceding aspect, wherein the aluminum alloy matrix comprises aluminum and one or more alloying elements selected from the group consisting of: copper, magnesium, manganese, nickel, silicon, silver, tin and zinc.

A third aspect relates to the method of any preceding aspect, wherein the nanoscale ceramic particles comprise a ceramic selected from the group consisting of a metal carbide, a metal oxide, metal beryllide, and/or a metal boride.

A fourth aspect relates to the method of any preceding aspect, wherein the nanocale ceramic particles comprise a ceramic selected from the group consisting of: titanium diboride, titanium carbide, tungsten carbide, zirconium oxide, yttrium oxide, and lanthanum oxide.

A fifth aspect relates to the method of any preceding aspect, wherein processing powders into a billet comprises: blending microscale metal particles and the nanoscale ceramic particles to form decorated particles; and after the blending, compacting the decorated powders to form the billet.

A sixth aspect relates to the method of the preceding aspect, wherein blending the powders comprises mixing in a polar fluid, followed by removal or evaporation of the polar fluid.

A seventh aspect relates to the method of the fifth or sixth aspect, wherein the nanoscale ceramic particles are included in an amount of at least about 0.1% by volume and as much as about 5% by volume.

An eighth aspect relates to the method of any of the fifth through the seventh aspects, wherein the microscale metal particles comprise elemental powders, master alloy powders, and/or prealloyed aluminum powders.

A ninth aspect relates to the method of any of the fifth through the eighth aspects, wherein the microscale metal particles have an average particle size of at least about 3 microns, at least about 5 microns, and/or as high as 35 microns.

A tenth aspect relates to the method of any of the fifth through the ninth aspects, wherein compacting the decorated powders comprises hot pressing under vacuum conditions.

An eleventh aspect relates to any preceding aspect, wherein an extrusion or area ratio between the billet and the extruded preform is in a range from about 30:1 to about 60:1, or from about 40:1 to about 50:1.

A twelfth aspect relates to any preceding aspect, wherein forming the MMC feedstock material comprises drawing the extruded preform into wire.

An thirteenth aspect relates to the preceding aspect,, wherein drawing the extruded preform into wire comprises multiple drawing steps with intermediate anneals.

A fourteenth aspect relates to the twelfth or thirteenth aspect, wherein a diameter of the wire is as small as 1 mm.

A fifteenth aspect relates to any preceding aspect, wherein forming the MMC feedstock material comprises atomizing the extruded preform into powder.

A sixteenth aspect relates to the method of the preceding aspect, wherein the powder has an average particle size in a range from about 10 microns to about 100 microns, or from about 25 microns to about 60 microns.

A seventeenth aspect relates to the method of any preceding aspect, further comprising fabricating a metal matrix composite component layer by layer from the MMC feedstock material.

An eighteenth aspect relates to a method of additively manufacturing a metal matrix composite component, the method comprising: processing powders into a billet, the billet comprising a metal matrix composite including nanoscale ceramic particles embedded in an aluminum alloy matrix; extruding the billet into an extruded preform, whereby the nanoscale ceramic particles are substantially fully embedded within grains and/or grain boundaries of the aluminum alloy matrix; forming a feedstock material for additive manufacturing from the extruded preform, the nanoscale ceramic particles remaining substantially fully embedded within the aluminum alloy matrix; and fabricating a metal matrix composite (MMC) component layer by layer from the feedstock material.

A nineteenth aspect relates to the method of the preceding aspect, wherein forming the feedstock material comprises drawing the extruded preform into wire.

A twentieth aspect relates to the method of the eighteenth or nineteenth aspect, wherein forming the feedstock material comprises atomizing the extruded preform into powder.

A twenty-first aspect relates to the method of any of the eighteenth through the twentieth aspects, wherein fabricating the MMC component layer by layer comprises: delivering the feedstock material into a printhead; melting the feedstock material to form a molten material; and depositing the molten material onto a substrate while the printhead is moved relative to the substrate, the molten material solidifying during or after deposition and being deposited in successive layers, thereby fabricating the MMC component layer by layer.

A twenty-second aspect relates to the preceding aspect, wherein the melting of the feedstock material occurs within the printhead and/or at an outlet of the printhead.

A twenty-third aspect relates to the twenty-first or twenty-second aspect, wherein the melting of the feedstock material is effected using a laser, an electron beam, or an electric arc.

A twenty-fourth aspect relates to the method of any of the eighteenth through the twenty-third aspects, wherein fabricating the MMC component layer by layer comprises: depositing the feedstock material onto a substrate to form a layer; melting one or more selected regions of the layer; cooling to solidify the one or more selected regions; and repeating the depositing, melting and cooling to form the MMC component layer by layer.

A twenty-fifth aspect relates to the method of the preceding aspect, wherein the feedstock material comprises powders.

A twenty-sixth aspect relates to the method of the twenty-fourth or twenty-fifth aspect, wherein the melting of the feedstock material is carried out using a laser.

A twenty-seventh aspect relates to the method of any of the twenty-fourth through the twenty-sixth aspects, further comprising: collecting excess feedstock material from outside the one or more selected regions of the layer; and reusing the excess feedstock material to fabricate an additional layer or additional MMC component.

A twenty-eighth aspect relates to the method of the eighteenth aspect, wherein fabricating the MMC component layer by layer comprises: delivering the feedstock material into a nozzle; and spraying the feedstock material out of an opening of the nozzle and onto a substrate in successive layers while the nozzle is moved relative to the substrate, the feedstock material adhering to the substrate, thereby forming the component layer by layer.

A twenty-ninth aspect relates to the method of the preceding aspect, wherein the spraying is carried out at a temperature at which the feedstock material remains in a solid state.

A thirtieth aspect relates to the method of any of the eighteenth through the twenty-ninth aspects, further comprising, during or after fabrication of the component, collecting excess feedstock material for recycling and/or reuse.

A thirty-first aspect relates to the method of any of the eighteenth through the thirtieth aspects, further comprising, after fabricating the MMC component layer by layer, carrying out one or more additional process steps to obtain a desired final microstructure.

A thirty-second aspect relates to the method of the preceding aspect, wherein the one or more additional process steps include hot isostatic pressing and/or heat treatment.

A thirty-third aspect relates to the method of any of the eighteenth through the thirty-second aspects, wherein the aluminum alloy matrix comprises aluminum and one or more alloying elements selected from the group consisting of: copper, magnesium, manganese, nickel, silicon, silver, tin and zinc.

A thirty-fourth aspect relates to the method of any of the eighteenth through the thirty-third aspects, wherein the nanoscale ceramic particles comprise a ceramic selected from the group consisting of a metal carbide, a metal oxide, metal beryllide, and/or a metal boride.

A thirty-fifth aspect relates to the method of any of the eighteenth through the thirty-fourth aspects, wherein the nanocale ceramic particles comprise a ceramic selected from the group consisting of: titanium diboride, titanium carbide, tungsten carbide, zirconium oxide, yttrium oxide, and lanthanum oxide.

A thirty-sixth aspect relates to the method of any of the eighteenth through the thirty-fifth aspects, wherein the nanoscale ceramic particles remain stable during melting and solidification of the aluminum alloy matrix.

A thirty-seventh aspect relates to the method of any of the eighteenth through the thirty-sixth aspects, wherein the nanoscale ceramic particles are wettable by molten aluminum.

A thirty-eighth aspect relates to the method of any of the eighteenth through the thirty-seventh aspects, wherein the nanoscale ceramic particles promote a columnar to equiaxed grain conversion during recrystallization of the aluminum alloy matrix.

A thirty-ninth aspect relates to a MMC feedstock material formed by the method of any of the first through the seventeenth aspects and comprising a metal matrix composite including an aluminum alloy matrix and nanoscale ceramic particles substantially fully embedded within the aluminum alloy matrix

A fortieth aspect relates to an additively manufactured component formed by the method of any of the eighteenth through the thirty-eighth aspects and comprising a metal matrix composite including an aluminum alloy matrix and nanoscale ceramic particles embedded within the aluminum alloy matrix.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed. Unless otherwise indicated or the context suggests otherwise, as used herein, “a” or “an” means “at least one” or “one or more.”

While various embodiments have been described, it will be apparent to those of ordinary skill in the art that many more embodiments and implementations are possible. Accordingly, the embodiments described herein are examples, not the only possible embodiments and implementations.

What is claimed is:

1. A method of fabricating a metal matrix composite feedstock material for additive manufacturing, the method comprising:
processing powders into a billet, the billet comprising a metal matrix composite including nanoscale ceramic particles embedded in an aluminum alloy matrix;
extruding the billet into an extruded preform, whereby the nanoscale ceramic particles are substantially fully embedded within grains and/or grain boundaries of the aluminum alloy matrix; and
forming a metal matrix composite (MMC) feedstock material for additive manufacturing from the extruded preform, the nanoscale ceramic particles remaining substantially fully embedded within the aluminum alloy matrix.

2. The method of claim 1, wherein the aluminum alloy matrix comprises aluminum and one or more alloying elements selected from the group consisting of: copper, magnesium, manganese, nickel, silicon, silver, tin and zinc.

3. The method of claim 1, wherein the nanoscale ceramic particles comprise a ceramic selected from the group consisting of a metal carbide, a metal oxide, metal beryllide, and/or a metal boride.

4. The method of claim 1, wherein the nanoscale ceramic particles comprise a ceramic selected from the group consisting of: titanium diboride, titanium carbide, tungsten carbide, zirconium oxide, yttrium oxide, and lanthanum oxide.

5. The method of claim 4, wherein the nanoscale ceramic particles are included in an amount of at least about 0.1% by volume and as much as about 5% by volume.

6. The method of claim 1, wherein processing powders into a billet comprises: blending microscale metal particles and the nanoscale ceramic particles to form decorated particles; and after the blending, compacting the decorated powders to form the billet, and
wherein the microscale metal particles comprise elemental powders, master alloy powders, and/or prealloyed aluminum powders.

7. The method of claim 1, wherein the microscale metal particles have an average particle size in a range from about 3 microns to about 35 microns.

8. The method of claim 1, wherein forming the MMC feedstock material comprises drawing the extruded preform into wire.

9. The method of claim 1, wherein forming the MMC feedstock material comprises atomizing the extruded preform into powder.

10. A MMC feedstock material formed by the method of claim 1 and comprising a metal matrix composite including an aluminum alloy matrix and nanoscale ceramic particles substantially fully embedded within the aluminum alloy matrix.

11. A method of additively manufacturing a metal matrix composite component, the method comprising:
processing powders into a billet, the billet comprising a metal matrix composite including nanoscale ceramic particles embedded in an aluminum alloy matrix;
extruding the billet into an extruded preform, whereby the nanoscale ceramic particles are substantially fully embedded within grains and/or grain boundaries of the aluminum alloy matrix;
forming a feedstock material for additive manufacturing from the extruded preform, the nanoscale ceramic particles remaining substantially fully embedded within the aluminum alloy matrix; and
fabricating a metal matrix composite (MMC) component layer by layer from the feedstock material.

12. The method of claim 11, wherein forming the feedstock material comprises drawing the extruded preform into wire.

13. The method of claim 11, wherein forming the feedstock material comprises atomizing the extruded preform into powder.

14. The method of claim 11, wherein fabricating the MMC component layer by layer comprises:
delivering the feedstock material into a printhead;
melting the feedstock material to form a molten material; and
depositing the molten material onto a substrate while the printhead is moved relative to the substrate, the molten material solidifying during or after deposition and being deposited in successive layers, thereby fabricating the MMC component layer by layer.

15. The method of claim 11, wherein fabricating the MMC component layer by layer comprises:
depositing the feedstock material onto a substrate to form a layer;
melting one or more selected regions of the layer;
cooling to solidify the one or more selected regions; and
repeating the depositing, melting and cooling to form the MMC component layer by layer.

16. The method of claim 11, wherein fabricating the MMC component layer by layer comprises:
delivering the feedstock material into a nozzle; and
spraying the feedstock material out of an opening of the nozzle and onto a substrate in successive layers while the nozzle is moved relative to the substrate, the feedstock material adhering to the substrate, thereby forming the component layer by layer.

17. The method of claim 11, further comprising, during or after fabrication of the component, collecting excess feedstock material for recycling and/or reuse.

18. The method of claim 11, wherein the aluminum alloy matrix comprises aluminum and one or more alloying elements selected from the group consisting of: copper, magnesium, manganese, nickel, silicon, silver, tin and zinc.

19. The method of claim 11, wherein the nanoscale ceramic particles comprise a ceramic selected from the group consisting of a metal carbide, a metal oxide, metal beryllide, and/or a metal boride.

20. An additively manufactured component formed by the method of claim 11 and comprising a metal matrix composite including an aluminum alloy matrix and nanoscale ceramic particles embedded within the aluminum alloy matrix.
